(19) United States
(12) Patent Application Publication
(10) Pub. No.: US 2005/0211680 A1
(43) Pub. Date: Sep. 29, 2005

(54) Systems and methods for laser texturing of surfaces of a substrate

(76) Inventors: Mingwei Li, San Jose, CA (US); Winston O. Soboyejo, Skillman, NJ (US)

Correspondence Address: HELLER EHRMAN LLP, 275 MIDDLEFIELD ROAD, MENLO PARK, CA, 94025-3506, US

(21) Appl. No.: 11/043,896

(22) Filed: Jan. 25, 2005

Related U.S. Application Data
(63) Continuation of application No. 10/445,266, filed on May 23, 2003.
(60) Provisional application No. 60/539,445, filed on Jan. 26, 2004.

(51) Int. Cl. B23K 26/38

(52) U.S. Cl. 219/121.68; 219/121.69

(57) ABSTRACT

The present application is directed to a method of modifying a surface of an article and includes irradiating pulsed laser light output at repetition rates in excess of about 1kHz, directing the laser light to a spot on the surface, and producing micro-grooved surfaces having one or more grooves formed thereon, the grooves having groove depths in the range of about 1 μm to about 100 μm.

### CROSS-REFERENCE TO RELATED APPLICATIONS

The present application claims priority to U.S. Provisional Patent Application Ser. No. 60/539,445, filed Jan. 26, 2004, the contents of which are incorporated by reference in its entirety herein.

### BACKGROUND

1. Field of the Invention

This invention relates generally to systems and methods for texturing surfaces, and more particularly to systems and methods for texturing a surface on a substrate while reducing or eliminating the formation of micro-cracks and other deleterious collateral damage zones in the substrate.

2. Description of the Related Art

There are many applications that require a roughened or textured surface on a substrate. To date, various methods have been utilized to produce conically shaped grooves forming a texturing pattern on a surface of the substrate, including etching, blast texturing, stamping, abrading, laser treatment, and the like. For example, U.S. Pat. No. 6,350,506, discusses one method of producing textured surfaces on glass or glass-ceramic substrates.

In recent years, biomedical implants having a textured or structured surface have been shown to impart therapeutic benefits to surrounding tissue structures when implanted. In particular, surface texturing has been shown to enhance adhesion and integration to tissue, reduce scar formation, and moderate immune responses. Further, surface texturing of a device may be used to deliver therapeutic agents to a targeted site within the body of a patient. In one example, U.S. Pat. No. 6,261,322 discloses a device having structured surfaces having biocompatible composite coatings positioned thereon. By way of illustration, in other examples, texturing of a bone surface to prepare a proper scaffolding for bone graft has been described-in U.S. Pat. No. 5,112,354 and U.S. patent application Ser. No. 2001/0039454; texturing of a dental implant was disclosed in U.S. Pat. No. 6,419, 491, and utilization of texturing patterns including pronounced undercut area below the datum surfaces of surgical implants was taught in U.S. Pat. No. 6,599,322.

Presently, a number of techniques are employed for forming a textured surface on a substrate. For example, the substrate may undergo a blast texturing technique wherein a portion of the substrate is subjected to abrasive material. Typical abrasive materials include Al₂O₃ or SiC. While the blast texturing technique has proven successful in forming a texture surface in the past, a number of shortcomings have been identified. For example, it is often difficult if not impossible to control the orientation of the texturing formed on the substrate. As such, random bone cell orientations may develop as a result of the random orientation of the texturing, thereby resulting in the formation of scar tissue proximate to the implanted device. Further, abrasive particles may become embedded in substrate and may induce diffusion which gives rise to significant alteration in the surface/near-surface chemistry. As such, undesirable elements, such as Al or V, may be unintentionally delivered to the implantation site.

Recently, micro-grooved geometries formed on a surface of the substrate have been used to promote contact guidance on biomedical surfaces. (contact guidance is a term for cells that grow directionally into the grooves on the surface of the material). As a result, the extent of scar tissue formation is reduced while promoting osseo-integration. Generally, micro-grooved geometries have been formed using a variety of techniques, including laser-processing techniques. One advantage of laser processing is that these techniques may be used in a non-contact mode and employ low input heat. In one example, U.S. Pat. No. 5,322,988 discloses the use of laser irradiation to impart a texture at a surface immersed in an ambient gas in an effort to improve a silicon-based device performance such as a CCD. In this method, a high energy UV laser, such as an excimer, is used to promote a chemical reaction between an ambient and a surface thereby imparting texture to the surface. In another example, more closely related to medical implants, U.S. Pat. No. 5,645,740 discloses using an excimer laser to micro-texturize the surface of an implant. An approach based on use of excimer lasers in conjunction with photolithographic masking techniques was also described in the above mentioned U.S. Pat. No. 6,599,322. Still another method of laser processing, in this case, of stent preforms, was taught in U.S. Pat. No. 6,563,080, where a method of cutting patterns with long pulse (microseconds) laser radiation was described.

While these techniques have proven successful in forming a texture on the surface of a substrate, a number of shortcomings have been identified. For example, it is recognized that use of excimer lasers, with their large pulse energy has some serious disadvantages. In particular, the high pulse energy associated with excimer lasers often results in extensive micro-cracks created in the substrate. Considerable heat affected zone formation and other undesirable collateral damage effects may also observed in the microstructure of the grooves upon use of a high intensity excimer as well as other lasers with high energy and long pulse durations. Micro-cracks and heat-affected zones are known to degrade subsequent fatigue performance.

In light of the foregoing, there is an ongoing need for a system and method capable of controllably forming a texture surface on a substrate. More specifically, the texturing system and methods may be configured to provide a textured surface on a substrate while reducing or eliminating the formation of micro-cracks and other deleterious collateral damage zones in the substrate.

### SUMMARY

An object of the present invention is to provide improved systems, and their methods of use, for forming a textured surface on a substrate.

Another object of the present invention is to provide systems, and their methods of use, for controllably forming a texture surface on a substrate.

A further object of the present invention is to provide systems, and their methods of use, for forming a texture surface on a substrate while reducing the formation of micro-craks and other collateral damage zones in the substrate.

These and other objects of the present invention are achieved in a method of modifying a surface of an article that includes irradiating pulsed TEM₀₀ laser light output at repetition rates in excess of about 1 kHz. The laser light is directed to a spot on the surface. Micro-grooved surfaces are produced that have one or more grooves formed thereon, the grooves having groove depths in the range of about 1 μm to about 100 μm.

In another embodiment of the present invention, a system is provided for producing grooves on a surface of an article. The system a diode pumped, solid state laser configured to irradiate at least one output beam. An output beam directing device is provided that directs at least a portion of the output beam to a target material having at least one surface. A controller device is coupled to at least one of the laser and output beam device. The controller. device is configured to control delivery of the output beam to the surface of the target material.

In another embodiment of the present invention, a system for producing grooves on a surface of an article includes a diode pumped, solid state laser. The laser is configured to irradiate at least one pulsed output beam having a pulse duration of about 1 ns to about 100 ns, a repetition rate in excess of about 1 kHz, and a pulse energy in the range of about 0.2 mJ to about to 5 mJ. An output beam directing device directs at least a portion of the output beam to a target material having at least one surface. A controller device is coupled to at least one of the laser and output beam device. The controller device is configured to control delivery of the output beam to the surface of the target material.

Other features and advantages of the embodiments of the systems and methods disclosed herein will become apparent from a consideration of the following detailed description.

### BRIEF DESCRIPTION OF THE DRAWINGS

Various embodiments of a method and system for laser texturing a substrate will be explained in more detail by way of the accompanying drawings, wherein:

FIG. 1 is a schematic diagram of one embodiment of a laser system whicht can be utilized for texturing a substrate;

FIG. 2a shows scanning electron microscopy photographs of excimer laser ablated grooves formed on a substrate;

FIG. 2b shows another scanning electron microscopy photographs of excimer laser ablated grooves formed on a substrate;

FIG. 3a shows the results of alignment/contact guidance of cells in a textured surface;

FIG. 3b shows the results of alignment/contact guidance of cells in a textured surface;

FIG. 4a shows one embodiment of scanning electron microscopy photographs of micro-grooved substrate geometries formed with methods disclosed in the present application;

FIG. 4b shows one embodiment of scanning electron microscopy photographs of micro-grooved substrate geometries formed with methods disclosed in the present application;

FIG. 4c shows one embodiment of scanning electron microscopy photographs of micro-grooved substrate geometries formed with methods disclosed in the present application;

FIG. 5a shows another embodiment of scanning electron microscopy photographs of the micro-grooved substrate geometries formed with methods disclosed in the present application;

FIG. 5b shows another embodiment of scanning electron microscopy photographs of the micro-grooved substrate geometries formed with methods disclosed in the present application;

FIG. 5c shows another embodiment of scanning electron microscopy photographs of the micro-grooved substrate geometries formed with methods disclosed in the present application;

FIG. 5d shows another embodiment of scanning electron microscopy photographs of the micro-grooved substrate geometries formed with methods disclosed in the present application;

FIG. 6a shows scanning electron microscopy photographs of etched cross-sections formed with methods disclosed in the present application;

FIG. 6b shows scanning electron microscopy photographs of etched cross-sections formed with methods disclosed in the present application;

FIG. 6c shows scanning electron microscopy photographs of etched cross-sections formed with methods disclosed in the present application;

FIG. 6d shows scanning electron microscopy photographs of etched cross-sections formed with methods disclosed in the present application;

FIG. 7a shows scanning electron microscopy photographs of cells growing on intersections of grooved and polished regions formed with methods disclosed in the present application;

FIG. 7b shows scanning electron microscopy photographs of cells growing on intersections of grooved and polished regions formed with methods disclosed in the present application;

FIG. 7c shows scanning electron microscopy photographs of cells growing on intersections of grooved and polished regions formed with methods disclosed in the present application;

FIG. 7d shows scanning electron microscopy photographs of cells growing on intersections of grooved and polished regions formed with methods disclosed in the present application;

FIG. 7e shows scanning electron microscopy photographs of cells growing on intersections of grooved and polished regions formed with methods disclosed in the present application;

FIG. 7f shows scanning electron microscopy photographs of cells growing on intersections of grooved and polished regions formed with methods disclosed in the present application;

FIGS. 8a illustrates another embodiment of scanning electron microscopy images of micro-grooved geometries formed with methods disclosed in the present application;

FIGS. 8b illustrates another embodiment of scanning electron microscopy images of micro-grooved geometries formed with methods disclosed in the present application;

FIG. 9 shows a schematic diagram illustrating one embodiment of a groove geometry formed with methods disclosed in the present application;

FIG. 10a shows another embodiment of scanning electron microscopy photographs of cells growing on intersection of grooved and polished regions formed with methods disclosed in the present application;

FIG. 10b shows another embodiment of scanning electron microscopy photographs of cells growing on intersection of grooved and polished regions formed with methods disclosed in the present application;

FIG. 10c shows another embodiment of scanning electron microscopy photographs of cells growing on intersection of grooved and polished regions formed with methods disclosed in the present application;

FIG. 10d shows another embodiment of scanning electron microscopy photographs of cells growing on intersection of grooved and polished regions formed with methods disclosed in the present application;

FIG. 10e shows another embodiment of scanning electron microscopy photographs of cells growing on intersection of grooved and polished regions formed with methods disclosed in the present application;

FIG. 10f shows another embodiment of scanning electron microscopy photographs of cells growing on intersection of grooved and polished regions formed with methods disclosed in the present application;

FIG. 11 shows an illustration of groove wall deformations on a laser micro-grooved formed with methods disclosed in the present application;

FIG. 12 shows an illustration of striations and resolidification packets on a laser micro-grooved surface formed with methods disclosed in the present application; and

FIG. 13 illustrates scanning electron micrographs of substrate specimens showing the heat affected zone, fused layer, as well as solidification cracking formed with methods disclosed in the present application.

### DETAILED DESCRIPTION

The present application is directed to various systems and methods for laser texturing of a substrate or a material applied thereto. More specifically, various systems and methods for providing surface roughening with a well defined texture or pattern, with minimal side-effects, including but not limited to micro cracking, collateral thermal effects, denaturing, and the like are disclosed herein. The various embodiments disclosed herein may be utilized in a variety of different applications. For example, in one embodiment the systems and methods disclosed herein may be used in applying a texture to at least one surface of a biomedical implant. Exemplary biomedical implants include, without limitation, stents, drug-eluting stents or devices, bioMEMS, prosthetic devices, plates, shunts, heart valves, screws, fasteners, pins, aneurysm closure devices, and the like. In the alternative, the systems and methods disclosed herein may be used in the processing of bioMEMS, industrial micro-machining, marking, decorative texturing, magnetic disc etching and the like. In certain embodiments, a high repetition rate UV laser with nanosecond pulse durations and high repetition rates in excess of several kHz is utilized. In other embodiments, and for different types of materials, a short pulse infrared or visible laser with femto- or pico-second long pulses may be beneficially utilized. In general, it is understood that texturing using a laser and a system in very localized ablation sites on a substrate falls within the scope of the invention. For example, U.S. patent application Ser. No. 10/445,266, entitled Laser Texturing Of Surfaces For Biomedical Materials, which is incorporated by reference in its entirety herein, discloses various methods and systems for laser texturing. Further, diode-pumped Q-switched or mode-locked lasers may be especially adapted for the computer-controlled processing of implants in a minimally complex and economical manner.

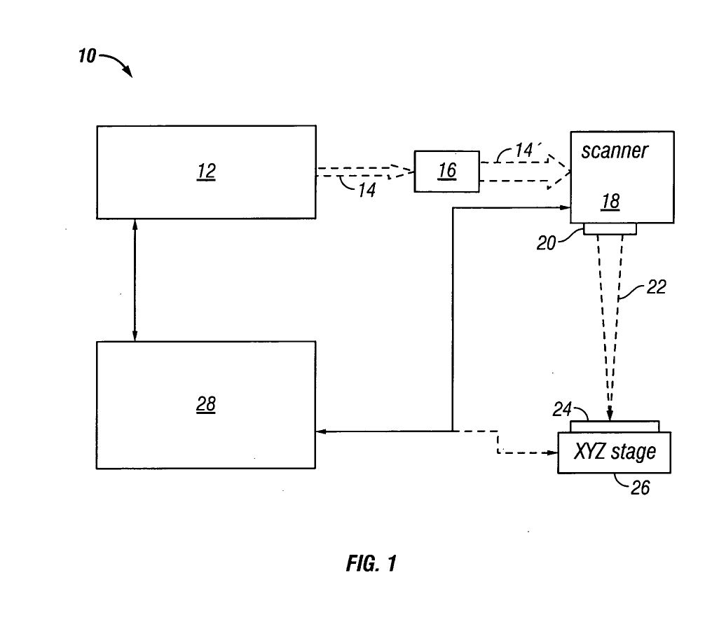

FIG. 1 illustrates one embodiment of a laser system for use in laser texturing. As shown, the laser system 10 includes a pulsed laser 12 that produces a beam 14. In one embodiment, laser 12 comprises a diode pumped, Q-switched solid state laser that operates with adjustable repetition rates, pulse energies and pulse durations, as discussed further below. Optionally, any number and variety of alternate laser systems may be used in the texturing process. In one embodiment, the laser 12 is capable of producing nanosecond pulses between 1 ns and 100 ns. Further, the laser system 10 can be operated over a range of repetition rates. For example, the laser system 10 may be operated at a repetition rate generally exceeding 1 kHz.

Referring again to FIG. 1, the laser 12 may be configured to irradiate light at any variety of wavelengths. For example, in one embodiment the laser 12 is configured to emit energy at UV wavelengths between 330 and 400 nm. Those skilled in the art will appreciate that these wavelengths are known to be especially effective in producing well-defined micro grooves on a variety of materials including metals and alloys. Given that materials such as Ti have a threshold that must be exceeded to produce a groove, average laser powers are may within the range of about 0.2W and to about 15W at any variety of wavelengths, depending on the material and pattern requirements. For example, in one embodiment, the wavelength of the laser light is about 355 nm. Optionally, the laser system 10 may comprise a mode-locked laser operating with picosecond pulse durations and MHz repetition rates.

As shown in FIG. 1, the beam 14 may be incident on one or more optical elements 16 prior to entering a scanner 18. Exemplary optical elements include, without limitation, lenses or lens systems, pinholes, filters, polarizers, mirrors, modulators, choppers, shutters, and the like. In the illustrated embodiment, the optical element 16 enlarges the diameter of the beam 14, thereby producing an output beam 14′. Refering again to FIG. 1, any variety or number of scanners may be used with the laser system 10. For example, in one embodiment the scanner 18 comprises a commercial scanner devices. In an alternate embodiment, the scanner 18 may comprise mirrors, plates, beam directors, and the like. In one embodiment, scanner 18 includes an f-theta objective 20 to focus beam 22 to a target material 24. Target material 24 can be mounted on an XYZ stage 26. Optionally, the system 10 may be configured such that the laser 12, the scanner 18, and/on the stage 26 are controllably movable. For example, the laser 12, the scanner 18, and/or the stage 26 may be mounted on a XYZ stage.

Referring again to FIG. 1, the laser system 10 may include a controller device 28 in communication with the laser 12, the scanner 18, and/or the stage 26. The controller device 28 may be configured to provide a variety of control signals to the laser 12, the scanner 18, and/or the stage 26. In one embodiment, the controller device 28 may be configured to form a control and feed-back loop between a computer driving laser 12 and the scanner 18. As such, the feed-back loop may be configured to allow for automated and/or hands-off operation. Optionally, the controller device 28 may be configured to control the repetition rate and scan patterns in response to computer commands received from a computer in communication therewith. In one embodiment, the controller device 28 is configured to provide information relative to at least one of, groove depth, groove width and output beam spot overlap.

In one embodiment, the laser surface modification techniques disclosed herein may be used to achieve improved bone/implant integration. In contrast to the blast textured surfaces which may give rise to random cell orientations, biomedical surfaces which are laser-textured may promote contact guidance, thereby reducing scar tissue formation during healing. For example, in one embodiment UV radiation from a pulsed solid state laser can be effectively utilized to produce micro-grooved surfaces having groove depths selected by the manufacturer on a substrate or on a material or coating positioned on the substrate. As such, the texturing may be applied to the substrate itself or a coating thereon. In one embodiment, biological implants may include one or more grooves having a groove depth from about 1 micron to about several hundred microns, depending on the physical characteristics of the device to be textured. For example, a hip replacement implant may include one or more grooves having groove depths on the order of about 2 μm to about 16 μm. Those skilled in the art will appreciate that any number of grooves of any desired groove depth may be produced using the systems and methods disclosed herein. In one embodiment, the grooves formed on the device may be substantially equal in length, depth, orientation, shape, and the like. In an alternate embodiment, the grooves formed on the device may have of varying length, depth, orientation, shape, and the like.

In one embodiment, the laser 12 comprises a diode pumped solid state laser (“DPSS”) frequency-converted and configured to irradiate UV energy, which is particularly suited for treating the bio-compatible materials commonly used to coat implants used in medical and dental applications. In one embodiment, the laser 12 may comprise an end-pumped solid state laser configuration which is known to offer excellent beam quality, high efficiency, overall safety, ease of installation, and long term stability. Exemplary commercial frequency tripled DPSS 355 nm lasers, such as those made by Spectra-Physics, Mountain View, California, may provide about 10W of TEM₀₀ output energy. Alternative diode pumped lasers include pulsed fiber lasers currently being developed by several companies, including, but not limited to IPG Photonics, Southampton Photonics and JDS Uniphase. When configured in a pulsed amplifier configuration, and using polarization maintaining, double-clad, or photonic fibers, these systems may produce output powers in excess of about 20W to about 50W at wavelengths ranging from 1030 to 1080 nm. Further, frequency tripling techniques using standard nonlinear conversion methods may be capable of producing well over 10W at wavelengths ranging from about 340 nm to 360 nm. Therefore, power levels of about 5W to about 10W may be generally sufficient for many of the applications contemplated in the present application, assuming pulse durations in the 1 ns to 110 ns range and kHz repetition rates. Those skilled in the art will appreciate, however, that the system disclosed herein may be configured to produce laser pulses having pulse durations ranging from about 75 fs to about 750 ns.

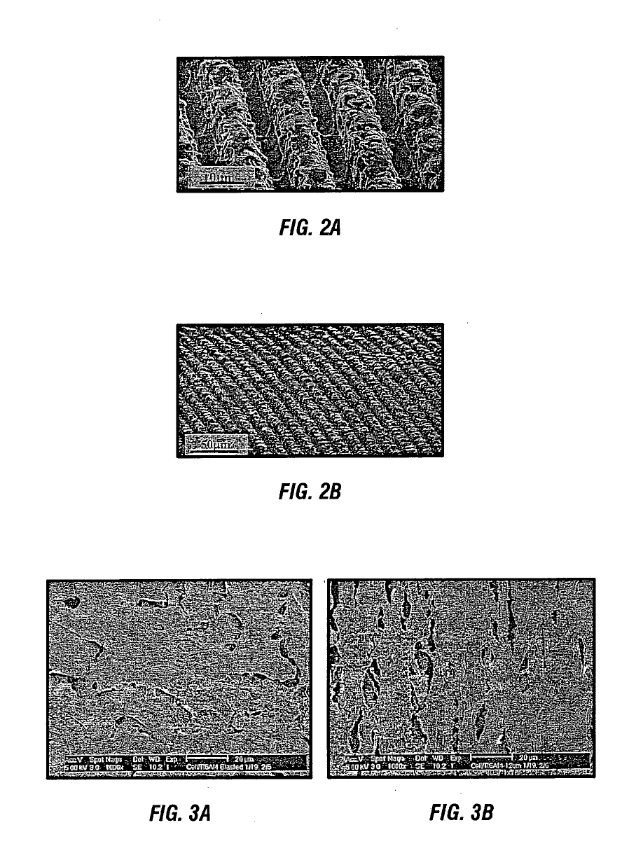

Further, end-pumped configuration are known to have outputs that are relatively low in energy (up to a few millijoules) and have high repetition rates (generally in excess of a few kHz to over 100 kHz). Many materials, including without limitation titanium and other metal alloys of interest, have ablation thresholds on the order of about 5 joules per square centimeter to about 95 joules per square centimeter. Therefore, small area focusing techniques may be feasible, using overlapping pulses, and computer-controlled algorithms, to produce the desired patterns. A flying spot scanning technique may be used to reduce the potential for formation of cracks and heat affected zones within the micro-grooved structures, thereby enhancing the longevity of the processed materials. In contrast, FIGS. 2(a) and 2(b) illustrate SEM photographs of ablated grooves that were created with an excimer laser, and show that the presence of micro-cracks and heat affected zones.

Disclosed below are several examples of systems and methods used to manufacturing textured surfaces on biologically compatible implants. The systems and methods disclosed below further illustrate the general concept of the present invention and are not intended to limit the scope and nature of the invention. Those skilled in the art will appreciate that any variety of materials for any variety of uses may be processed using the systems and methods disclosed herein.

### EXAMPLE 1

A Q-switched, diode pumped solid-state (DPSS) UV laser was used to fabricate micro-groove geometries on a titanium alloy surface. The DPSS laser was utilized to introduce micro-groove geometries, with a variety of cells such as sarcoma and osteoblasts, with depths between approximately about 6 μm and about 150 μm in Ti and Ti-6Al-4V alloys. Further, micro-groove geometries having depths of approximately about 8 μm and about 16 μm may be produced by the appropriate control of pulse frequency, repetition rate and the number of scans.

### EXAMPLE 2

Groove dimensions and geometries were studied in relation to laser processing parameters. By way of illustration, and without limitation, nano-second UV laser processing parameters were investigated relative to the geometry and microstructure of a mill annealed Ti-6Al-4V alloy. The laser processing parameters, including but not limited to pulse repetition rate, feed speed, wavelength, and the like, were varied in order to produce micro-grooves with depths of approximately 12 μm. In one embodiment, optimal micro-groove geometries were shown to promote the contact guidance that can give rise to reduced scar tissue formation and improved osseo-integration.

Contact guidance of human osteosarcoma (HOS) cells on laser micro-grooved Ti6Al4V surfaces was achieved using the methods disclosed herein. As a result and accompanied by the lack of micro-structural defects, such as heat affected zones and micro-cracks, the devices modified using the systems and methods provided for herein provided a more efficient way of achieving contact guidance. These results indicate that textured surfaces produced by frequency-tripled diode pumped lasers, such as the Navigator II YHP40 laser made by Spectra-Physics, Inc., Mountain View, Calif., may be effective in the intended manipulation of cell orientation and may provide tissue engineers with a more efficient alternative in laser texturing than with an excimer laser.

Further, the performance of implants fabricated from DPSS laser-textured Ti-6Al-4V may be improved when micro-grooved geometries are used to align cells and promoted contact guidance on biomedical surfaces. FIGS. 3(a) and 3(b) illustrate the difference between alumina blasted surface and a laser micro-grooved surface. As shown in FIG. 3(a), a random orientation of cells on the rough surface was observed as compaired with the alignment/contact guidance of cells on the micro-grooved sample shown in FIG. 3(b).

### EXAMPLE 3

### Cell Surface Interactions

HOS cells were used in a 2-day cell culture experiment on laser micro-grooved Ti6Al4V surfaces to investigate the cell-surface interactions between HOS cells and laser micro-grooved Ti6Al4V surfaces.

### Cell Culture

HOS cells were maintained at 37° C. in humid 5% CO₂-95% air. The culture medium was 89% DEEM, 10% fetal bovine serum, and 1% penicillin/streptomycin. Thereafter, the cells were split 1:5 whenever confluence was reached. The cells were harvested using trysin at 0.25% concentration. The cells were then centrifuged down to a pellet at 3500 revolutions per minute and resuspended in 1 mL of medium.

### Ti6Al4V Surfaces

Micro-grooves were produced on the surfaces of two Ti-6Al-4V samples having approximate dimensions ¼″ X ¼″ X ½″, using a Spectra Physics Navigator II YHP40 laser having a laser output of 355 nm (UV). The samples were cut from a ¼″ thick bend bar specimen and mechanically polished utilizing colloidal silica for the final polishing step.

Parallel grooves were produced on the samples by varying the processing parameters of pulse repetition rate, feed speed, and wavelength. Unlike the first investigation which utilized a focal length of about 160 mm, a focal length of about 100 mm was utilized in the secondary investigation. The processing parameters used in the surface grooving of the samples were the same as those used in the processing of samples before. All processing was completed with a single beam pass. Each sample included polished and micro-grooved surfaces.

Before seeding the sample surfaces, the surfaces of the samples were cleaned and passivated. Each surface was first sonicated in a solution of distilled water and detergent for about 30 minutes and rinsed in deionized water 3 times for at least 1 minute. Each surface was sonicated in acetone for about 30 minutes and rinsed in deionized water 5 times for at least 1 minute. The samples were then passivated in 30% nitric acid for about 15 minutes and rinsed in deionized water 5 times for at least 1 minute. Each sample was sterilized in 100% ethanol for about 30 minutes and dried in a sterile hood.

### Preparation for SEM Analysis

After two days, the surfaces were removed from the media and rinsed in 0.1M sodium phosphate buffer and fixed overnight in 0.1M sodium phosphate buffer with 3% gluteraldehyde. Thereafter, the surfaces were dehydrated via a stepwise, 30 minutes each step, alcohol dehydration (30%, 50%, 70%, 80%, 90%, 95%, 100% ethanol). The cells were then critical point dried in CO₂. The surfaces were fixed to SEM stubs and sputter-coated with a gold-palladium alloy to create a conducting surface for subsequent scanning electron microscopy.

### Characteristics of the Micro-grooves

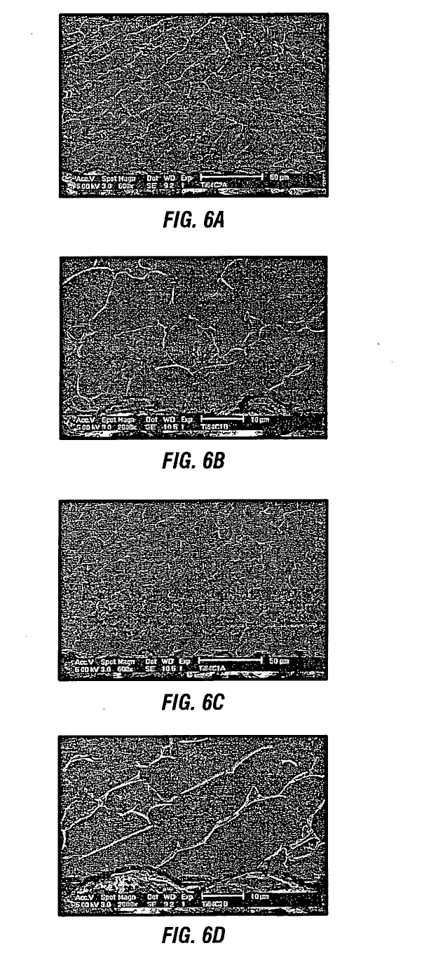

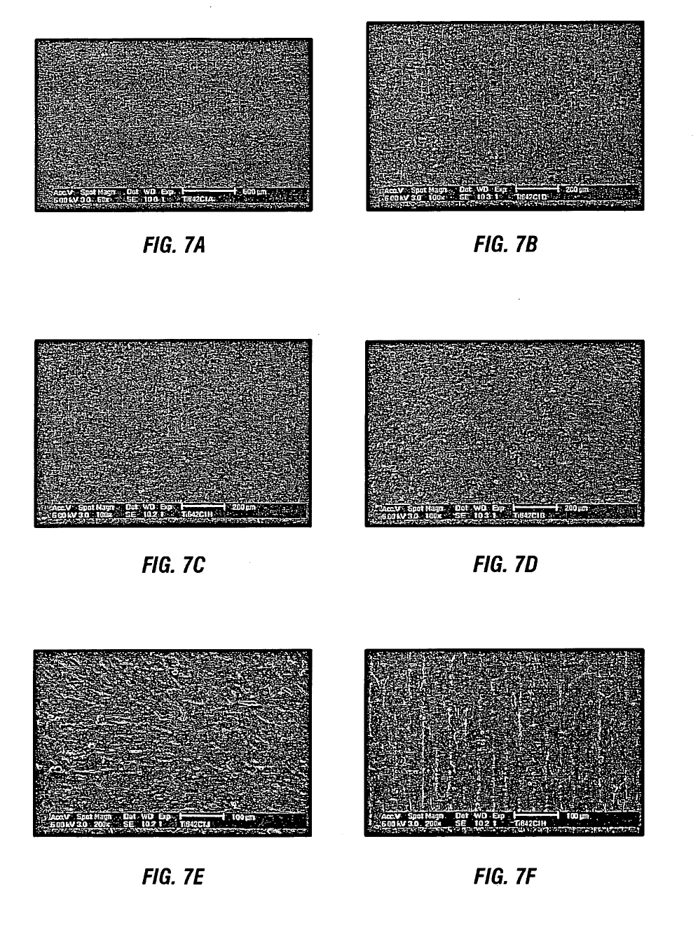

Micrographs of the samples were obtained using a Philips XL-30 Field Emission Scanning Electron Microscope (SEM). Top-view and side-view micrographs were taken of the sample surfaces to measure groove dimensions, examine the effects of the processing parameters on groove geometry, to study observable physical characteristics. FIGS. 6a-6d and 7a-7d represent the SEM images of the groove sections for samples C1 & C2. The sample labels C1 and C2 are representative of the fact that the samples were processed using the same parameters as those used for Sample C/Section 1 and Sample C/Section 2 respectively in the secondary investigation.

TABLE 1
Measured groove geometries Ti—6Al—4V.

| Sample | Groove | Groove Depth |
|---|---|---|
| # | Width (μm) | (μm) |
| Cl | 25 | 11 |
| C2 | 26 | 8 |

### Observations of Physical Characteristics

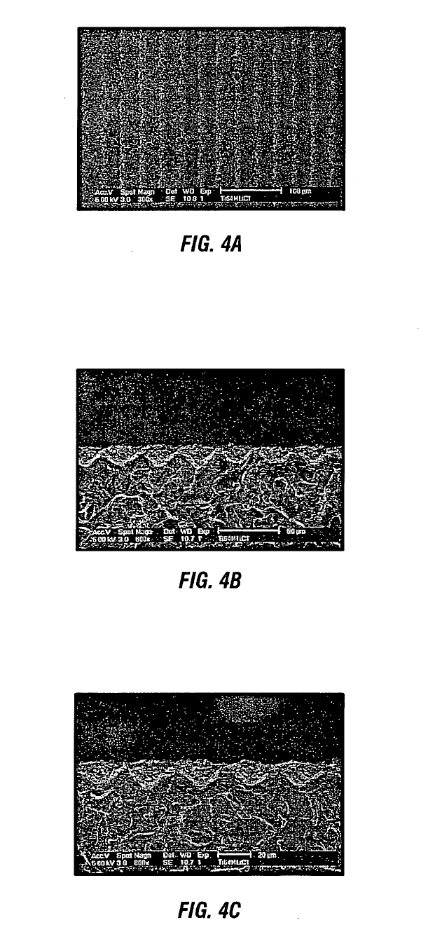

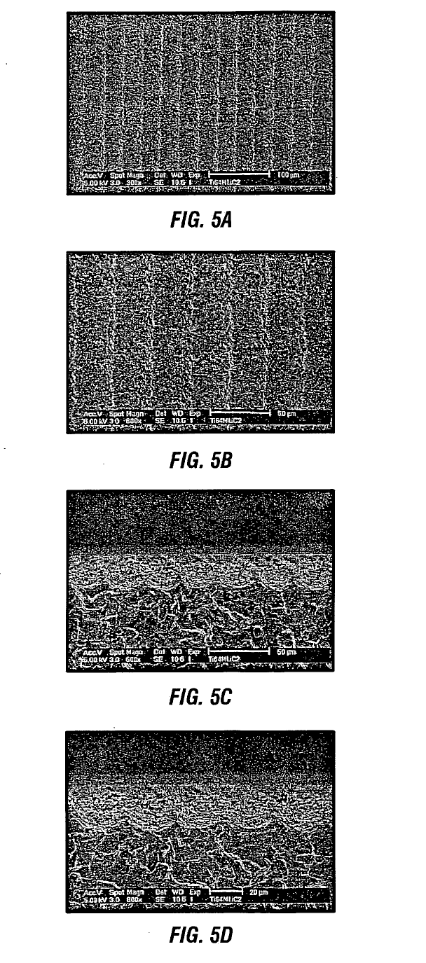

With reference to FIGS. 4a-4c and 5a-5d and Table 1, a difference between these samples and those produced in the secondary investigation with identical processing parameters relates to the groove width. One possible explanation for the discrepancy is the possibility of a slight difference in the height of corresponding samples. Another possibility is that the laser processing was affected by its optical limit and thus failed to reproduce the exact results reached in the secondary investigation.

### Microstructure

Prior work with excimer lasers showed evidence of micro-cracks and heat-affected zones as a result of texture processing. The presence of micro-cracks and heat affected zones on a sample is of concern because they represent deleteriously affected regions on the substrate that can negatively affect how cells respond to the substrate. In contrast,no such phenomena were observed in the microstructure of the micro-grooved samples produced in laser processing by the methods and laser systems disclosed herein, as illustrated in FIGS. 5a-5d, manufactured using a Spectra Physics Navigator II YHP40 laser.

### Cell Surface Interactions

Scanning electron microscopy at 5 kV was used to observe the cell morphology on the micro-grooved Ti6Al4V surfaces. On the surfaces of C1 and C2, the intended contact guidance along the grooves was the morphological result of cells seeded on the micro-grooved portion of the sample. Contact guidance of a different nature was the morphological result of cells seeded on the polished portion of the sample: the cell orientation followed the direction of the submicron grooves created on the sample surface during the polishing process as shown in FIGS. 6a-6d and 7a-7e.

### EXAMPLE 4

### Optimization of the Micro-groove Laser Processing of Ti6Al4V Surface using a DPSS Laser

A parametric study was conducted of UV laser processing parameters, including pulse repetition rate, feed speed and wavelength, on micro-geometry, topology and microstructure. The results from the preliminary set of experiments indicated that the micro-grooves developed at a laser output of 355 nm (UV) produced grooves closest to the optimal groove geometries. A second parametric study was performed in which a wavelength of 355 nm was used, and the feed speed and pulse repetition rate were varied. The second set of experiments also employed a focal length of 100 mm. A shorter focal length lens was used to achieve a smaller spot size, and consequently smaller groove dimensions. All the laser processing was completed with a single beam pass. The second set of laser processing parameters is summarized in Table II.

TABLE II
Second set of processing parameters used for the
surface grooving of Ti—6Al—4V.

| | Pulse | Feed | | |
|---|---|---|---|---|
| Groove | Repetition | Speed | Average power | Spacing between |
| Section # | Rate (kHz) | (mm/s) | on sample (W) | grooves (μm) |
| 1 | 50 | 200 | 1.9 | 30 |
| 2 | 50 | 300 | 1.9 | 30 |
| 3 | 40 | 200 | 2.6 | 30 |
| 4 | 40 | 300 | 2.6 | 30 |
| 5 | 60 | 100 | 1.3 | 30 |
| 6 | 60 | 200 | 1.3 | 30 |

### Micro-groove Geometry

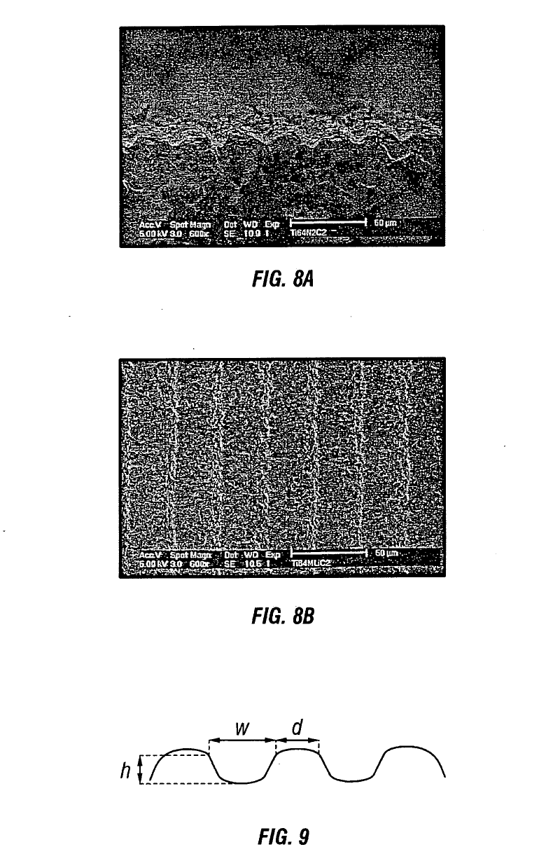

The geometries of the micro-grooved samples were examined using a Philips XL-30 Field Emission Scanning Electron Microscope (SEM). An exemplary top-view and cross-sectional view are presented in FIGS. 8(a) and 8(b). These figures show a uniform micro-groove geometry and surface topography. A cross-sectional view of one embodiment of the groove geometry is shown in FIG. 9, in which the groove dimensions are also illustrated. The measured groove dimensions are summarized in Table III.

TABLE III
Measured groove geometries of Ti—6Al—4V samples

| Groove Section | Spacing between | Groove width | Groove Depth |
|---|---|---|---|
| # | grooves (μm) | (μm) | (μm) |
| 1 | 16.9 | 14.1 | 11 |
| 2 | 14.1 | 14.1 | 10 |
| 3 | 14.1 | 18.4 | 10 |
| 4 | 14.1 | 18.4 | 9 |
| 5 | 15.0 | 16.9 | 18 |
| 6 | 16.9 | 16.9 | 5 |

### Micro-groove Surface Topology

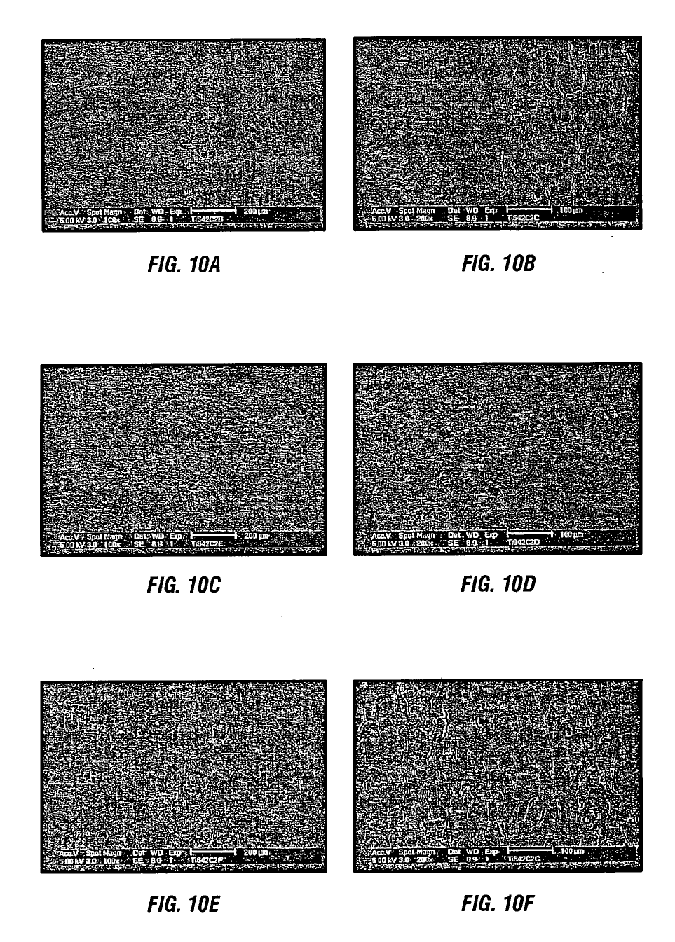

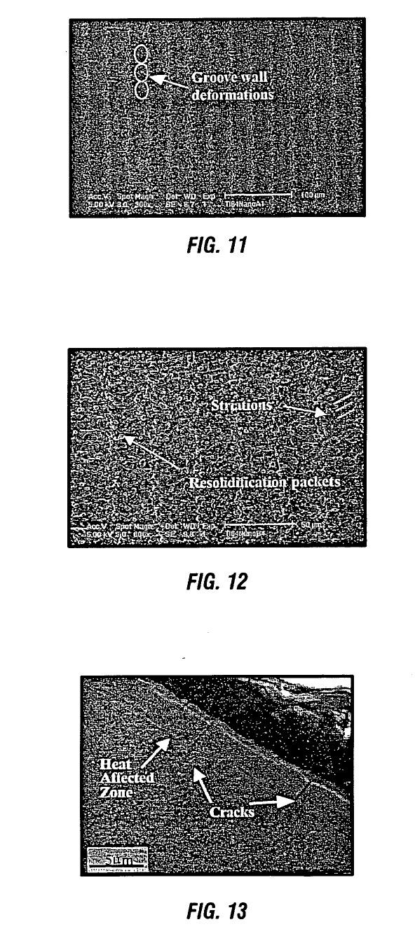

Three general types of surface features were observed on the laser processed samples. These included: resolidification packets, striations and the deformation of groove walls in the form of repeated round sections along the lengths of the grooves, as illustrated in FIGS. 10 and 11.

The resolidification packets represent areas where the laser melted the surface of the titanium alloy, and the material resolidified. In the preliminary set of experiments, resolidification packet size and incidence were observed to increase with increasing wavelength. Results from the secondary set of experiments suggest that resolidification packet size and incidence increase slightly with the combination of increasing average power (a function of wavelength) and decreasing pulse repetition rate.

Referring again to FIG. 11, the striations appear as oblique lines running along the length of the grooves and develop within the grooves during laser processing. A comparison of the distance traveled along the sample, between laser pulses and the mean spacing between striations, in the preliminary set of experiments, suggests these physical marks are due to the pulse repetition the of the laser. Because the sample travels a certain distance between pulses, the striations are created each time the laser removes material from each pulse.

Further, in the preliminary parametric study, the striations were only evident in the grooves produced with a 355 nm wavelength. The lack of evidence of striations in the second investigation suggests that the appearance of this physical phenomenon may be the result of multiple factors: depth, level of resolidification, and size of resolidification packets in the actual grooves. The depth factor was considered because the grooves containing striations in the preliminary set of experiments were below seven microns in depth. The resolidification factor was suggested because resolidification in the grooves conforms to the pattern of the striations.

In the preliminary experimental tests, the deformation of the groove walls may have been the result of a variety of factors, including, without limitation, motion of the mechanized stage and a function of the laser spot size. If the motion of the sample is not continuous, but rather staggered, then the round or wave like appearance of the walls may be due to the momentary pause of the laser and represent the spot size of the laser. The second parametric study supports this hypothesis, as a smaller spot size was used in the laser process. Observations from this second study showed that the repeated round sections were much smaller than the ones in the preliminary parametric study.

### Microstructures of Laser Micro-grooved Surfaces

As compared to sample processed using an excimer laser, no evidence of heat-affected zones or cracking was observed in the microstructure of the micro-grooved samples produced by UV laser processing using the Spectra Physics Navigator II YHP40 laser. FIG. 12 shows a microscopic investigation of a sample processed using an excimer laser. The duplex microstructure present prior to processing was similar to that of the post-processed samples, FIG. 12. This again suggests that frequency-tripled diode pumped UV laser processing is a better alternative to excimer laser processing.

Ultraviolet (355 nm) laser processing and the appropriate selection of parameters such as feed speed, pulse repetition rate, and average power on sample led to the groove dimensions deemed optimal for contact guidance of cells. In these experiments micro-groove geometries of about 8 μm to about 12 μm in width and depth were found to promote, contact guidance and cell integration as determined in an early study. Other materials and implant requirements may require larger or smaller grooves. In general, the system and methods disclosed herein are compatible with producing dimension between about 1 μm and about 50 μm or more, sufficient to meet the needs of all the applications considered. Variations in the groove depths can be readily achieved by control of wavelength, pulse frequency, and feed speed. These parameters may be easily controllable by a user with any variety of laser systems, including, without limitation, UV laser sources, diode pumped solid state lasers, slab lasers, fiber lasers, and the like.

Ultraviolet laser processing produced three observable physical characteristics: resolidification packets, groove wall deformations, and striations. These characteristics may a function of a number of laser parameters including pulse repetition rate, feed speed, wavelength, laser spot size, the mechanical motion of the processing stage, and the like.

Relatively straight and uniform micro-grooves were also produced in Ti-6Al-4V using solid-state lasers operated at various wavelengths, (355 nm—UV, 535 nm—green, and 1064 nm—IR), pulse frequencies (40 kHz, 50 kHz, and 60 kHz), and feed speeds (100 mm/s, 200 mm/s, and 300 mm/s). Unlike the excimer lasers, no evidence of heat affected zones or solidification cracks were observed in the micro-grooves produced using the solid-state lasers.

The micro-grooves developed with a pulse frequency of about 50 kHz, a focal length of about 100 mm, feed speeds ranging from about 200 mm/s to about 300 mm/s, and a wavelength of about 355 nm produced micro-groove geometries near the targeted groove width and depth of approximately 12 μm. These micro-grooves had respective depths and widths of approximately 11 μm and approximately 14 μm. Further adjustments to the groove geometry may be achieved by control of lens focal length that controls the spot size, pulse repetition rates, feed speeds and striation spacing. Also, processing results may be further varied by varying mechanical stage motions, laser spot sizes and wall deformations.

The foregoing examples illustrate that the application of micro-grooves to surfaces may result in contact guidance and cells alignment within grooves during cell spreading and proliferation. Further, contact guidance was shown to improve wound healing and minimize scar tissue formation. Ordered proliferation may be the result of two phenomena, the first of which is based upon minimum free energy or path of least resistance and the second is due to the ability of the cells to maintain the necessary intracellular communications.

### EXAMPLE 5

### Stents

Stents are mechanical scaffolds which may be implanted within the vascularture of a patient to provide support thereto. In one application, stents are used to keep arteries from re-narrowing following balloon angioplasty procedures commonly performed to treat atherosclerosis or narrowing of the blood vessels due to fat deposits. It is known that stents may be inserted in the arteries to alleviate restenosis, or a reobstruction of blood vessels following balloon angioplasty due to elastic recoil and tissue remodeling. However, the secondary formation of scar tissue within the lumen adjacent to the implanted stent has been observed. Commonly, this phenomena is referred to as stent restenosis. Recently, drug-eluted stents have been developed to reduce or eliminate this unwanted effect. Generally, these drug-eluting stents comprise mechanical supports coated with one or more protective or therapeutic coatings. Exemplary coating include, polymers, therapeutic substances, anti-metabolites, and other materials known to inhibit scar tissue formation. Further, the coating may also enhance wound healing in a vascular site, provide for improved adhesion properties, and/or improve the structural and elastic properties of the vessel. In another development, stents, which are typically made of stainless steel or titanium, may be textured. Thus, a laser system such as the one illustrated in FIG. 1 of the present application may be utilized to create micro-grooves on the surface of the stent.

Following initial processing, a coating may be deposited on the textured surface of the stent. In one example employed in the art, the polymer can be dissolved in a solvent that is applied to the stent with the therapeutic substance can be dissolved or dispersed in the composition. The solvent is then evaporated to form the coating. Optionally, the one or more coatings may be applied to the stent using any number of methods known in the art. If desired, the coating may comprise an active agent that includes any substance capable of exerting a therapeutic or prophylactic effect. In general such prior art techniques of drug elution incur additional cost due to multiple processing steps. It would therefore be a desirable outcome, if scar formation could be inhibited by virtue of optimal texture patterns imposed directly on the stent. to thereby allow contact guidance and reduce scar formation. The necessary micro-grooves can be readily produced without undesirable side-effect using the scanning small spot techniques disclosed herein, since the materials forming the stent can be readily ablated. It is understood that the methods and systems disclosed herein may be compatible with stents that may or may not be coated.

### EXAMPLE 6

### Bio-MEMS Devices

MEMS have been suggested for in-vivo use in an number of applications, including micron-scale pressure sensors and drug delivery systems. To date, attempts at developing implantable bioMEMS devices has proven challenging. One potential reason for this stems from the fact that the majority of MEMS materials are not very biocompatible and by the complex issues related to the adhesion and integration of implants to cells. More specifically, silicon, which has been ubiquitous in the fabrication of MEMS devices presents issues due to its relative cytotoxicity. Furthermore, successful bioMEMS integration requires the fusion of material surfaces with the surrounding tissue. In understanding the establishment of mechanically solid interfaces, insight into both the macro and micro-scale features is necessary. In general, macro-scale features will influence the gross biomechanical stress and strain transfer between implant and tissue, while micro-scale features affect cell-implant interactions more directly. Thus an understanding of cell adhesion on materials with varied surface topography may be of assistance in the enhancement of cell/biomaterial integration. In prior art studies, it has been observed that the amplitude and organization of the surface roughness will influence adhesion and proliferation. More specifically, less organized surfaces with relatively high micro-roughness amplitudes will exhibit less proliferation. The results of the study presented herein confirm the promise of coating micro-textured silicon surfaces with nano-scale liters of material (such as titanium) to thereby improve biocompatibility and promote contact guidance, leading to reduced potential for scar tissue formation.

### Experimental Parameters

An experimental study of cell/surface interactions on laser micro-textured titanium coated silicon surfaces that are relevant to bioMEMS structures was conducted. Silicon specimens were laser-irradiated at three different scan speeds in the horizontal and/or vertical directions of the scan field. An approximately 50 nm thick titanium layer was applied to the specimens using electron beam vapor deposition (EBBED) to assess their biocompatibility. Analyses of the treated samples was performed using scanning electron microscopy (SEM) and scanning white-light interferometer. The efficacy of cellular attachments to the micro-textured uncoated/coated specimens was evaluated so that implications with respect to integration into the human body could be better understood.

The single-crystalline silicon used in this study was in the form of n-type, phosphorus doped, (100) silicon wafers (Silicon Valley Microelectronics, San Jose, Calif.) with a diameter of about 100 mm and a thickness of about 375 microns. The nanosecond laser micro texturing was produced on rectangular specimens, approximately 6.5 mm×16.5 mm, sectioned from the silicon wafers. Following laser processing and cleaning an approximately 50 nm thick titanium coating (Denton 502, Moorestown, N.J.) was applied to the specimens using EBBED.

### Laser Processing

The silicon specimens were irradiated by nanosecond laser pulses generated by a Spectra-Physics HIPPO 355 nm diode-pumped solid-state laser. The laser was operated at a pulse repetition frequency (PRY) of about 100 kHz with a pulse width of about 15 ns and an average power of about 2.5W on the specimens. A hurrySCAN 10 laser scan head (SCANLAB AG, Puchheim, Germany) with an focal length of about 100 mm telecentric objective was used to focus and move the beam and the focal spot size was estimated to be approximately 10 microns. The specimens were mounted on a manual XYZ translational stage under the scan head. Scan speeds ranging from about 300 mm/s to about 800 mm/s were used to produce a series of laser ablated parallel micro-grooves along either the horizontal or vertical direction of the scan field or along both the horizontal and vertical directions. All processing was completed in a single beam pass and the parallel grooves were produced with a about 20-micron center-to-center spacing. Table III summarizes the processing parameters used in the production of the micro-grooved silicon specimens. Results from earlier studies indicated that the micro-grooves developed at a laser output of 355 nm (UV) and the processing parameters listed in Table III produced grooves closest to the optimal groove geometries.

### Surface Preparation

After the laser irradiation process, the silicon specimens were cleaned to remove SiO₂ deposits and loose particulate that had formed as part of the laser irradiation process. Briefly, the specimens were ultrasonically cleaned in a 1:5 aqueous solution of 48% hydrofluoric acid for about 30 minutes at ambient temperature and pressure, removed from solution, rinsed in doubled distilled H₂O and dried with N₂ gas. The silicon specimens were subsequently characterized using scanning electron microscopy and scanning white-light interferometry.

TABLE III
Processing parameters of UV laser micro-grooved silicon.

| | Pulse | Groove | | Focal | Scan | Incident |
|---|---|---|---|---|---|---|
| Specimen | Rate | Spacing | Power | Length | Speed | Direction to |
| # | (kHz) | (um) | (W) | (mm) | (mm/s) | Scan Field |
| 1 | 100 | 20 | 2.5 | 100 | 300 | Horizontal |
| 2 | 100 | 20 | 2.5 | 100 | 300 | Vertical |
| 3 | 100 | 20 | 2.5 | 100 | 300 | Horiz./Vert. |
| 4 | 100 | 20 | 2.5 | 100 | 500 | Horizontal |
| 5 | 100 | 20 | 2.5 | 100 | 500 | Vertical |
| 6 | 100 | 20 | 2.5 | 100 | 500 | Horiz./Vert. |
| 7 | 100 | 20 | 2.5 | 100 | 800 | Horizontal |
| 8 | 100 | 20 | 2.5 | 100 | 800 | Vertical |
| 9 | 100 | 20 | 2.5 | 100 | 800 | Horiz./Vert. |

### Surface Characterization

Pre and post cleaning inspections of the irradiated surface regions were performed by means of scanning electron microscopy. A Philips XL-30 field emission scanning electron microscope (SEM) was used to characterize the surface morphology of the laser-induced features.

A detailed surface metrology of the laser-modified areas was performed with a Zygo 3-D surface profiler (Middlefield, Conn.) using scanning white-light interferometry.

### Cell Culture

To test the biocompatibility of the silicon specimens and determine their efficacy for cell spreading and adhesion under physiological conditions, human osteosarcoma cells (HOS; ATCC, Manassas, Va.) were incubated with the micro-textured surfaces for 2 days.

Prior to cell seeding, the samples were cleaned and sterilized. Briefly, each sample was ultrasonically cleaned in a solution of double distilled water (dd H₂O) and detergent for 20 minutes, followed by a rinse in dd H₂O. All samples were then sterilized in 100% ethanol for 5 minutes and dried with nitrogen gas before being placed in culture plates.

The HOS cells were cultured in 25 cm² flasks (Becton-Dickinson, Franklin Lakes, N.J.) and maintained in an incubator at an incubation temperature of 37° C. regulated with 5% CO₂, 95% air, and a saturated humidity. A Dulbecco's Modified Eagle Medium (DMEM) supplemented with 10% Fetal Bovine Serum and 1% penicillin/streptomycin/amphotericin B was used as the cell culture medium (Quality Biological, Giathersburg, Md). At confluence, the cells were sub-cultured by splitting.

The cell suspension was prepared following customary methodology (see Milburn et al in Journal of Material science: materials in Medicine, in preparation).

### Biological Fixation and SEM Preparation

To facilitate scanning electron microscopy, the specimens were biologically fixed and critically-point-dried, following a two-day incubation period. The samples were then examined using a Philips XL-30 Field Emission Scanning Electron Microscope with an accelerating voltage of 5 or 10 kV.

### Results

Laser-irradiated zones produced at three different scan speeds (about 300 mm/s, about 500 mm/s, and about 800 mm/s) were selected for a more detailed visual and surface metrological characterization. The zones produced during the laser ablation process consist of micro-grooves produced by irradiating in either the horizontal or vertical direction of the scan field and micro-grids formed by irradiating in both the horizontal and vertical directions of the scan field. SEM images were as described in Cell/Surface Interactions On Laser Microgrooved and Titanium-coated Silicon Surfaces, by S. Mwenifumbo, M. Li, and W. Soboyejo, which article is fully incorporated herein by reference. Regions could be qualitatively identified based on the observed surface morphology and debris patterns. The images generally show two distinct, but relatively uniform; surface morphologies: micro-grooves and micro-grids. Within these two distinct morphologies, three types of surface features were generally observed: resolidification packets, striations, and groove wall deformations.

The splatter patterns correspond to a violent expulsion of material from the grooves, which results in resolidified material and the deposition of solidified silicon droplets within and around the micro-textured regions. In earlier work, it was determined that resolidification packet size and incidence increased slightly by varying wavelength and pulse repetition rate. However, in this study a decrease in scan speed is observed to have a similar effect. A comparison of the distance traveled along the sample between laser pulses and the mean spacing between striations suggests these physical marks are due to the pulse repetition rate of the laser. Further, there was an absence of striations in the micro-textured surfaces produced with a scan speed of about 300 mm/s which may be a result of more pulse overlapping and material removal at the lower speed. The motion of the scan mirrors used may have contributed to the wall deformations (repeated round sections along the lengths of the grooves) observed within the parallel grooves. In addition, beam defocusing at certain locations of the specimen surfaces could result in an increase of the spot size, and therefore increase in the lateral size of the ablated grooves.

The surface morphology of the irradiated silicon samples may be changed by decreasing the scan speed. More specifically, a slower the scan speed results in an increase in the volume of displaced semiconductor material on the surface of the sample within and around the grooves or micro-grids. Moreover, the surface morphology suggested an explosive material removal. In lower scan speed regimes, some samples exhibited the presence of defects within and around the grooves and micro-grids, which have arisen as a result of more thermal input from the laser at lower speeds.

Zygo 3-D surface profiles for the laser-induced features of the specimens produced using the processing parameters listed in Table III were produced using Scanning white-light interferometry. The surface metrology characterization for the laser-irradiated surfaces is summarized in Table IV.

TABLE IV
Surface metrology of UV laser micro-textured silicon.

| | Groove | | | RMS Surface |
|---|---|---|---|---|
| | Spacing | Groove Width | Groove Height | Roughness |
| Specimen # | (um) | (um) | (um) | (um) |
| 1 | 20 | 12 | 11 | 3.948 |
| 2 | 20 | 12 | 11 | 4.039 |
| 3 | 20 | 12 | 14 | 4.456 |
| 4 | 20 | 11 | 9 | 2.468 |
| 5 | 20 | 11 | 9 | 2.452 |
| 6 | 20 | 11 | 12 | 3.534 |
| 7 | 20 | 10.5 | 8 | 1.523 |
| 8 | 20 | 10.5 | 7 | 1.455 |
| 9 | 20 | 10.5 | 10 | 3.262 |

The cross-sectional area below the original plane of the surface was found to scale approximately linearly with the scan speed. With a decrease in the scan speed, the depth of the laser-textured features increased. Moreover, the size of the affected area was slightly larger than the focal spot size (approximately 10 micron), where only the intensity of central part of the beam was significant enough to remove material. As such, this sensitivity may also means that the alignment of the focusing plane with sample surfaces may affect the texturing process. For example, a small degree of defocusing may lead to a rapid decrease in the beam intensity on the surface which can either cause fluctuations in the width and depth of the features or even reduce the intensity such that it is below the ablation threshold.

Cell spreading and morphology were also investigated. More specifically, on all the grooved specimens, the cells appeared to be oriented along the grooves. The cell aspect ratio (cell elongation) and the level of orientation along the groove directions were observed to decrease with decreasing groove depth and RMS roughness (increasing laser-processing scan speed). The cells cultured in the grooves processed at a scan speed of about 300 mm/s were seen at times to be aligned in deeper grooves with minimal lateral spreading, while the cells cultured on the about 800 mm/s scan speed surfaces showed a tendency to straddle the grooves more and ore ‘fuzzy-polygonal’ morphology. Although the micro-grooved surfaces were found to play a role in the aspect ratio and migration direction of the HOS cells (within the grooves the cells aligned with the axis of the grooves and movement of the HOS cells is relatively bi-directional along the axis of the grooves), the micro-grid patterns were observed to have different effects on the cells. Within the micro-grid patterns, the cells were less mobile, were found to attach to the tops of the bumps with relatively no alignment effects, and spreading minimal distances from the original location of application.

In addition, the random nature (topology/roughness) of the micro-groove and micro-grid patterns were found to affect the spreading, proliferation, and differentiation of 2-day cultured HOS cells.Specifically, spreading and proliferation rates were found to decrease with increasing RMS roughness; with cells cultured on the smooth surfaces having the highest spreading and proliferation rates. FIGS. 7a-7f9 demonstrate these differences in spreading and proliferation rates at two different interfaces.

On both the uncoated and coated smooth surfaces, HOS cells were widely spread and randomly oriented after the 2-day culture period. The cell coverage on the smooth titanium-coated surfaces (FIGS. 10a-10f), was observed to be more dense (near-confluence) than that of the native silicon surfaces. In general, all titanium-coated surfaces showed more dense cell coverage including the micro-groove and micro-grid specimens.

The application of approximately 50 nm thick titanium coating to both the smooth and micro-textured surfaces increased the biocompatibility of the silicon. The titanium coat was observed to effect cell growth and spreading. Spreading, proliferation, and cell density were all found to be greater on the titanium coated surfaces. In addition, the cells were observed to flatten out more on the coated surfaces than the native silicon surfaces, thereby confirming that a minimum coat thickness of a biologically compatible coating (e.g. approximately 50 nm of titanium)may improve biocompatibility while providing a more amiable habitat for the cells. Without complete coverage, regions of silicon may emerge through the coating layer and allow the cytotoxic effects of silicon to hinder cell growth.

In addition, virtually no visible morphological differences were observed in cell growth within each of the three distinct coated surface morphologies (smooth, micro-grooves, and micro-grids) with the exception of the cells cultured on the 800 mm/s scan speed micro-grooves, which developed a slight fuzzy-polygonal morphology. On smooth surfaces, the cells grew in a random fashion. The random nature of the growth may be a function of the lack of external signals or cues to the developing cells. It is hypothesized that within the body, tissues may develop using cues or signals that direct the growth and development of individual cells. These signals or cues may include soluble molecules that are transported by the medium, signal molecules that reside on the surfaces of cells, physical forces, and/or surface morphology.

The influence of external signals on cell development was examined through the use of micro-grooved surfaces. Such surfaces often result in contact guidance, which manipulates surface morphology to direct cell growth and movement. Prior studies indicated that topological modifications (multiple grooves) may align cells on substrates and reduce inflammatory effects in soft tissue. The degree of orientation depends on the cell type, surface material, and groove width and depth. On all micro-grooved surfaces, the cells aligned along the grooves, a higher cell density was observed in the grooved areas, and the grooves were found to significantly reduce cell down-growth, which may lead to implant encapsulation. As such, the grooves may be used to reduce implant encapsulation as well as scar tissue formation in bioMEMS devices.

The response of the HOS cells to the 300 mm/s and 500 mm/s scan speed grooved surfaces may result from the theory that cells react to discontinuities since the 300 mm/s and 500 mm/s specimens have larger and more numerous discontinuities than the 800 mm/s specimens. Further, the discontinuities may permit the condensation and the nucleation of actin. In one aspect, contact guidance may be explained by a mechanical-receptive response induced during actin polymerization, thereby suggesting that cells will achieve or attempted to achieve a balanced state where internal and external forces favor differentiation.

Alignment of cells cultured on micro-grooved samples results from the cells being subjected to a specific configuration of forces (function of groove geometry). As such, the actin spike, contained in lamellipodia at the front edges of cells, encounter a ridge or other surface irregularity (groove wall), unfavorable forces are exerted thereon thereby inhibiting actin polymerization. In response to these unfavorable forces, actin filaments may form and elongate along the groove direction (path of least resistance).

Groove depth has been found to play an important role in the interaction between cells and micro-grooves while groove spacing has been found to only slightly effect cell orientation. For the cultured HOS cells, a greater inhibition of groove crossing and a corresponding increase in alignment along the grooves occurred as the groove height increased. However, it is important to mention that the influence of height variations has been linked to cell type. A previous study has demonstrated that HOS cells lying within grooves have a highly organized cytoskeletal structure and thus are more likely to be impacted by the surface morphology, suggesting that cells with a less defined structure would be less affected. In a study by Clark et al., the fibroblasts, epithelial cells, and neurons were found to react strongly to the steps, while neutrophils were relatively unaffected.

Further, differences in proliferation rates were observed between the smooth surfaces and the micro-textured surfaces. In general, cells cultured on the smooth surfaces tended to reach confluence, while cell proliferation on the micro-groove and micro-grid patterns was lower. In contrast, differences in proliferation and attachment were not observed between the 300, 500, and 800 mm/s scan speed micro-groove surfaces, although these surfaces were different in their RMS roughness.

All the micro-grid samples showed substantially lower spreading and proliferation rates compared to the micro-groove specimens, despite the fact that their RMS roughness were similar to that of the 300 mm/s micro-groove specimens. These micro-grid pattern results coincide with recent studies which evaluate which surface features have a greater impact on cell proliferation: pillars (bumps) or depressions. In all cases of the uncoated and coated silicon, the upper surfaces of the specimens were found to have the an increased influence on HOS cell proliferation; attaching to the tops of the pillars. In addition, the cells spread with no alignment effects, resulting in random orientations.

The foregoing description of various embodiments of systems and methods for laser texturing a surface of a substrate has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A method of modifying a surface of an article, comprising:
irradiating pulsed TEM₀₀ laser light output at repetition rates in excess of about 1 kHz;
directing the laser light to a spot on the surface; and
producing micro-grooved surfaces having one or more grooves formed thereon, the grooves having groove depths in the range of about 1 μm to about 100 μm.

2. The method of claim 1, wherein the depths of the grooves range from about 10 μm to about 50 μm.

3. The method of claim 1, wherein the depths of the grooves range from about 2 μm to about 20 μm.

4. The method of claim 1, wherein the grooves have a width in the range of about 1 micron to about 50 microns.

5. The method of claim 1, further comprising pulsing the laser light at a repetition rate in the range of about 5 kHz to about 400 kHz.

6. The method of claim 1, wherein the pulsed TEM₀₀ laser light output is produced by a laser system that includes a controller in communication with the laser system.

7. The method of claim 6, further comprising:
providing at least one control signal to at least one of, the laser, a scanner coupled to the laser and a stage coupled to the scanner.

8. The method of claim 7, further comprising:
forming a feedback loop between the laser and the scanner.

9. The method of claim 8, further comprising:
using the feedback loop to allow at least one of, automated and hands-off operation.

10. The method of claim 9, further comprising:
using the feedback loop to control repetition rate of the laser and scan patterns of the scanner

11. An apparatus for producing grooves on a surface of an article, comprising:
a diode pumped, solid state laser configured to irradiate at least one output beam;
an output beam directing device that directs at least a portion of the output beam to a target material having at least one surface; and
a controller device coupled to at least one of the laser and output beam device, the controller device configured to control delivery of the output beam to the surface of the target material.

12. The apparatus of claim 11, wherein the laser is a UV laser.

13. The apparatus of claim 11, wherein the output beam has a wavelength in the range of about 200 nm to about −400 nm.

14. The apparatus of claim 11, wherein the laser is a pulsed laser.

15. The apparatus of claim 14, wherein the laser has a pulse duration of about 1 ns to about 100 ns.

16. The apparatus of claim 14, wherein the laser has a pulse duration of about 5 ps to about 500 ps.

17. The apparatus of claim 14, wherein the laser has pulse durations of about 1 fs to about 1 ps.

18. The apparatus of claim 14, wherein the laser has a repetition rate in excess of about 1 876 kHz.

19. The apparatus of claim 11, further comprising at least one optical element in optical communication with at least one of the laser and the beam directing device.

20. The apparatus of claim 19, wherein the optical element comprises a beam expander.

21. The device of claim 11, wherein the controller device includes a feedback controller configured to control at least one of the laser and the beam directing device.

22. The device of claim 21, wherein the controller device is configured to provide information relative to at least one of, groove depth, groove width and output beam spot overlap.

23. The system of claim 11, further comprising:
a stage coupled to the controller device.

24. The system of claim 23, wherein the controller device is configured to provide one or more control signals to at least one of, the laser, the output beam directing device, and the stage.

25. The system m of claim 24, wherein the controller device is configured to create a feedback loop between the laser and the output beam directing device.

26. The system of claim 25, wherein the feedback loop is configured to provide for at least one of, automated and hands-off operation of the laser.

27. The system of claim 23, wherein the controller device is configured to control repetition rate and scan patterns in response to a received signal.

28. The system of claim 23, wherein the controller device controller device is configured to provide information relative to at least one of, groove depth, groove width and output beam spot overlap.

29. The system of claim 11, wherein the output beam directing device is a scanner.

30. The device of claim 11, wherein the target material comprises a biologically compatible implantable device.

31. An apparatus for producing grooves on a surface of an article, comprising:
a diode pumped, solid state laser configured to irradiate at least one pulsed output beam having a duration rate of about 1 ns to about 110 ns, a repetition rate in excess of about 1 kHz, and a pulse energy in the range of about 0.2 mJ to about to 5 mJ;
an output beam directing device that directs at least a portion of the output beam to a target material having at least one surface; and
a controller device coupled to at least one of the laser and output beam device, the controller device configured to control delivery of the output beam to the surface of the target material.

32. The device of claim 31, wherein the laser has an output wavelength of about 200 nm to about 425 nm.

33. The system of claim 11, further comprising:
a stage coupled to the controller device.

34. The system of claim 33, wherein the controller device is configured to provide one or more control signals to at least one of, the laser, the output beam directing device, and the stage.

35. The system of claim 34, wherein the controller device is configured to create a feedback loop between the laser and the output beam directing device.

36. The system of claim 35, wherein the feedback loop is configured to provide for at least one of, automated and hands-off operation of the laser.

37. The system of claim 33, wherein the controller device is configured to control repetition rate and scan patterns in response to a received signal.

38. The system of claim 33, wherein the controller device controller device is configured to provide information relative to at least one of, groove depth, groove width and output beam spot overlap.

39. The system of claim 11, wherein the output beam directing device is a scanner.
